(19) United States
(12) Patent Application Publication
(10) Pub. No.: US 2008/0153938 A1
(43) Pub. Date: Jun. 26, 2008

(54) Surface Treatment of Fluorinated Biomedical Devices

(76) Inventors: George L. Grobe, Ft. Wayne, IN (US); Daniel J. Hook, Fairport, NY (US); Daniel M. Ammon, Webster, NY (US); Joseph C. Salamone, Boca Raton, FL (US)

Correspondence Address: Bausch & Lomb Incorporated, One Bausch & Lomb Place, Rochester, NY, 14604-2701, US

(21) Appl. No.: 11/934,937

(22) Filed: Nov. 5, 2007

Related U.S. Application Data
(60) Provisional application No. 60/870,858, filed on Dec. 20, 2006.

(51) Int. Cl. C08F 2/46

(52) U.S. Cl. 522/99

(57) ABSTRACT

A method for treating the surface of a fluorinated biomedical device is provided comprising the steps of (a) plasma treating the fluorinated biomedical device with a hydrogen-containing atmosphere to reduce the fluorine or C—F bonding content of the fluorinated biomedical device; and (b) subjecting the hydrogen plasma treated surface to a plasma-polymerization reaction in a hydrocarbon-containing atmosphere to form a polymeric carbonaceous layer on the surface of the biomedical device.

### CROSS-REFERENCE

This application claims the benefit of Provisional Patent Application No. 60/870,858 filed Dec. 20, 2006.

### BACKGROUND OF THE INVENTION

1. Technical Field

The present invention relates generally to methods for surface treating a fluorinated biomedical device.

2. Description of Related Art

Biomedical devices such as contact lenses made from fluorinated materials have been investigated for a number of years. Such materials can generally be subdivided into two major classes, namely hydrogels and non-hydrogels. Hydrogels can absorb and retain water in an equilibrium state whereas non-hydrogels do not absorb appreciable amounts of water. Regardless of their water content, both non-hydrogel and hydrogel fluorinated contact lenses tend to have relatively hydrophobic, non-wettable surfaces.

The art has recognized that introducing fluorine-containing groups into contact lens polymers can significantly increase oxygen permeability. For example, U.S. Pat. No. 4,996,275 discloses using a mixture of comonomers including the fluorinated compound bis(1,1,1,3,3,3-hexafluoro-2-propyl)itaconate in combination with organosiloxane components. U.S. Pat. Nos. 4,954,587; 5,010,141 and 5,079,319 disclose that fluorination of certain monomers used in the formation of silicone hydrogels has been indicated to reduce the accumulation of deposits on contact lenses made from such materials. Moreover, the use of silicone-containing monomers having certain fluorinated side groups, i.e., —(CF₂)—H, have been found to improve compatibility between the hydrophilic and silicone-containing monomeric units. See, e.g., U.S. Pat. Nos. 5,321,108 and 5,387,662. Other fluorinated contact lens materials have been disclosed, for example, in U.S. Pat. Nos. 3,389,012; 3,962,279; and 4,818,801.

Those skilled in the art have recognized the need for modifying the surface of fluorinated contact lenses so that they are compatible with the eye. It is known that increased hydrophilicity of a contact lens surface improves the wettability of the contact lenses. This, in turn, is associated with improved wear comfort of the contact lens. Additionally, the surface chemistry of the lens can affect the lens's susceptibility to deposition, particularly the deposition of proteins and lipids from the tear fluid during lens wear. Accumulated deposition can cause eye discomfort or even inflammation. In the case of extended-wear lenses, the surface is especially important, since extended-wear lenses must be designed for high standards of comfort over an extended period of time, without requiring daily removal of the lenses before sleep. Thus, the regimen for the use of extended-wear lenses would not provide a daily period of time for the eye to rest or recover from any discomfort or other possible adverse effects of lens wear during the day.

Contact lenses have been subjected to plasma surface treatment to improve their surface properties, with the intent to render their surfaces more hydrophilic, deposit resistant, scratch resistant, or otherwise modified. For example, plasma treatment to effect better adherence of a subsequent coating is generally known. U.S. Pat. No. 4,217,038 (“the '038 patent”) discloses, prior to coating a silicone lens with sputtered silica glass, etching the surface of the lens with an oxygen plasma to improve the adherence of a subsequent coating. U.S. Pat. No. 4,096,315 (“the '315 patent”) discloses a three-step method for coating plastic substrates such as lenses, preferably poly(methyl methacrylate) (PMMA) lenses. The method disclosed in the '315 patent involves (a) a first plasma treatment of the substrate to form hydroxyl groups on the substrate in order to allow for good adherence, (b) a second plasma treatment to form a silicon-containing coating on the substrate, and (c) a third plasma treatment with inert gas, air, oxygen, or nitrogen. The '315 patent states that pretreatment with hydrogen, oxygen, air or water vapor, the latter being preferred, forms hydroxy groups. Neither the '038 patent nor the '315 patent disclose the surface treatment of fluorinated contact lens materials in particular.

U.S. Pat. No. 4,312,575 (“the '575 patent”) discloses the use of hydrogen/fluorocarbon gaseous mixtures to treat silicone lenses. In Example 2 of the '575 patent, polydimethylsiloxane lenses are initially treated with a 50% hydrogen/50% tetrafluoroethylene mixture, followed by an oxygen plasma treatment. The '575 patent further discloses that when it is desired to utilize a halogenated hydrocarbon to perform the plasma polymerization process, hydrogen gas may be added to the halogenated hydrocarbon in order to accelerate the polymerization reaction. In particular, the '575 patent states that hydrogen may be added to the plasma polymerization apparatus in an amount ranging from about 0.1 to about 5.0 volumes of hydrogen per volume of the halogenated hydrocarbon. However, the '575 patent does not disclose how to surface treat fluorinated materials such as fluorosilicone hydrogel or highly fluorinated contact lens materials.

U.S. Pat. No. 4,631,435 discloses a plasma polymerization process employing a gas containing at least one compound selected from halogenated alkanes, alkanes, hydrogen and halogens in specific combinations, the atomic ratio of halogen/hydrogen in the aforesaid gas being 0.1 to 5 and the electron temperature of the plasma in the reaction zone being 6,000° K. to 30,000° K. The resulting coating is, in particular, suitable as the protective film for magnetic recording media.

U.S. Pat. Nos. 4,565,083; 5,034,265; 5,091,204; and 5,153,072 disclose a method of treating articles to improve their biocompatibility according to which a substrate material is positioned within a reactor vessel and exposed to plasma gas discharge in the presence of an atmosphere of an inert gas such as argon and then in the presence of an organic gas such as a halocarbon or halohydrocarbon gas capable of forming a thin, biocompatible surface covalently bonded to the surface of the substrate. The method is particularly useful for the treatment of vascular graft materials. The graft material is subjected to plasma gas discharge at 5-100 watts energy. Each of these patents does not discuss the surface treatment of a fluorinated contact-lens materials.

In view of the above, it would be desirable to provide an improved method for surface treating a fluorinated biomedical device such as a fluorinated contact lens to provide a biomedical device with an optically clear, hydrophilic surface film that will exhibit improved wettability and biocompatibility which can be made in a convenient and cost efficient manner. It would also be desirable to be able to surface treat a fluorinated hydrogel or non-hydrogel biomedical device that would allow its use in the human eye for an extended period of time.

### SUMMARY OF THE INVENTION

In accordance with one embodiment of the present invention, a method for treating a fluorinated biomedical device is provided comprising the steps of (a) plasma treating the fluorinated biomedical device with a hydrogen-containing atmosphere to reduce the fluorine or C—F bonding content of the fluorinated biomedical device; and (b) subjecting the hydrogen plasma treated surface to a plasma-polymerization reaction in a hydrocarbon-containing atmosphere to form a polymeric carbonaceous layer on the surface of the biomedical device.

In accordance with a second embodiment of the present invention, a method for treating a fluorinated biomedical device is provided comprising the steps of (a) plasma treating the fluorinated biomedical device with a hydrogen-containing atmosphere to reduce the fluorine or C—F bonding content of the fluorinated biomedical device; (b) oxidizing the surface with an oxidizing source; and (c) subjecting the oxidized surface to a plasma-polymerization reaction in a hydrocarbon-containing atmosphere to form a polymeric carbonaceous layer on the surface of the biomedical device.

In accordance with a third embodiment of the present invention, a method for treating a fluorinated biomedical device is provided comprising the steps of (a) plasma treating the fluorinated biomedical device with a hydrogen-containing atmosphere to reduce the fluorine or C—F bonding content of the fluorinated biomedical device; (b) oxidizing the surface with a first oxidizing source; (c) subjecting the oxidized surface to a plasma-polymerization reaction in a hydrocarbon-containing atmosphere to form a polymeric carbonaceous layer on the surface of the biomedical device and (d) oxidizing the polymeric carbonaceous layer with a second oxidizing source to provide reactive functionalities on the polymeric carbonaceous layer.

In accordance with a fourth embodiment of the present invention, a method for treating a fluorinated biomedical device is provided comprising the steps of (a) plasma treating the fluorinated biomedical device with a hydrogen-containing atmosphere to reduce the fluorine or C—F bonding content of the fluorinated biomedical device; (b) oxidizing the surface with a first oxidizing source; (c) subjecting the oxidized surface to a plasma-polymerization reaction in a hydrocarbon-containing atmosphere to form a polymeric carbonaceous layer on the surface of the biomedical device; and (d) oxidizing the polymeric carbonaceous layer with a second oxidizing source to provide reactive functionalities on the polymeric carbonaceous layer; and (e) reacting a biocompatible material with the reactive functionalities on the surface of the device.

In accordance with a fifth embodiment of the present invention, a method for treating a fluorinated biomedical device is provided comprising the steps of (a) plasma treating the fluorinated biomedical device with a hydrogen-containing atmosphere in the presence of an oxidizing source; and (b) subjecting the oxidized surface to a plasma-polymerization reaction in a hydrocarbon-containing atmosphere to form a polymeric carbonaceous layer on the surface of the biomedical device.

By first plasma treating the fluorinated biomedical device with a hydrogen-containing atmosphere in the method of the present invention, the fluorine content on the surface is reduced such that one or more subsequent steps can be carried out. It is believed that without a reduction in the fluorine content of the fluorinated biomedical device, the fluorine would detach from the surface of the device during a surface treatment step since fluorine is a highly reactive atom. Accordingly, by carrying out the steps of the methods of the present invention, the surface of the device can have improved wettability or biocompatibility.

### DETAILED DESCRIPTION OF THE PREFERRED EMBODIMENTS

The present invention is directed to the surface treatment of a fluorinated biomedical device intended for direct contact with body tissue or body fluid. Representative examples of fluorinated biomedical devices include, but are not limited to, artificial ureters, diaphragms, intrauterine devices, heart valves, catheters, denture liners, prosthetic devices, ophthalmic lens applications, where the lens is intended for direct placement in or on the eye such as, for example fluorinated intraocular devices and fluorinated contact lenses. As used herein, the term “ophthalmic device” refers to devices that reside in or on the eye. These devices can provide optical correction, wound care, drug delivery, diagnostic functionality or cosmetic enhancement or effect or a combination of these properties. A particularly preferred fluorinated contact lens is either a fluorinated silicone hydrogel material or a non-hydrogel material that is highly fluorinated. Useful fluorinated silicone-containing ophthalmic devices include fluorinated silicone-containing ophthalmic lenses such as soft contact lenses, e.g., a soft, hydrogel lens; soft, non-hydrogel lens and the like, hard contact lenses, e.g., a hard, gas permeable lens material and the like, intraocular lenses, overlay lenses, ocular inserts, optical inserts and the like. As is understood by one skilled in the art, a lens is considered to be “soft” if it can be folded back upon itself without breaking.

In general, hydrogels are a well-known class of materials which contain at least hydrated, cross-linked polymeric systems containing water in an equilibrium state. Non-hydrogels include elastomers and no-water or low-water xerogels. Fluorosilicone hydrogels generally have a water content greater than about 5 weight percent and more commonly between about 10 to about 80 weight percent. Fluorosilicone hydrogels (i.e., the bulk polymeric material from which it is formed) generally contains up to about 20 mole percent fluorine atoms and as low as about 1 mole percent fluorine atoms, which to some extent may become enriched near the surface, depending on the manufacturing process such as the hydrophobicity of the lens mold.

In one embodiment, a fluorinated polymeric material can contain about 5 to about 15 mole percent fluorine atoms, wherein the mole percents are based on the amounts and structural formula of the components in bulk of the fluorinated polymer making up the contact lens. Such materials are usually prepared by polymerizing a mixture containing at least one fluorinated silicone-containing monomer and at least one hydrophilic monomer. Typically, either the fluorosilicone monomer or the hydrophilic monomer functions as a crosslinking agent (a crosslinker being defined as a monomer having multiple polymerizable functionalities), or a separate crosslinker may be employed. Applicable fluorosilicone monomeric units for use in the formation of contact-lens hydrogels are well known in the art and numerous examples are provided in commonly assigned U.S. Pat. Nos. 4,810,764 and 5,321,108, the contents of which are incorporated by reference herein. Also applicable are the fluorinated materials (e.g., B-1 to B-14) disclosed in U.S. Pat. No. 5,760,100.

The fluorinated polysiloxane-containing monomers disclosed in U.S. Pat. No. 5,321,108 are highly soluble in various hydrophilic compounds, such as N-vinyl pyrrolidone (NVP) and N,N-dimethyl acrylamide (DMA), without the need for additional compatibilizers or solubilizers.

As used herein, the term “side group” refers to any chain branching from a siloxane group, and may be a side chain when the siloxane is in the backbone of the polymeric structure. When the siloxane group is not in the backbone, the fluorinated strand or chain which branches out from the siloxane group becomes a side chain off of the siloxane side chain.

The “terminal” carbon atom refers to the carbon atom located at a position furthest from the siloxane group to which the fluorinated strand, or side group is attached.

When the polar fluorinated group, —(CF₂)_{z}H, is placed at the end of a side group attached to a siloxane-containing monomer, the entire siloxane monomer to which the side group is attached is rendered highly soluble in hydrophilic monomers, such as NVP. When the hydrogen atom in the terminal fluorinated carbon atom is replaced with a fluoro group, the siloxane-containing monomer is significantly less soluble, or not soluble at all in the hydrophilic monomer present.

Examples of fluorinated siloxane-containing monomers useful in the present invention include those having at least one fluorinated side group, the side group being of general formula I:

-D-(CF₂)_{z}H (I)

wherein z is 1 to 20; and D is an alkyl or alkylene group having 1 to about 10 carbon atoms and which may have ether linkages between the carbon atoms.

Polymeric materials useful in the method of the present invention may also be polymerized from monomer mixtures containing at least fluorinated siloxane-containing monomers having at least one fluorinated side group and having a moiety of the following general formula II:

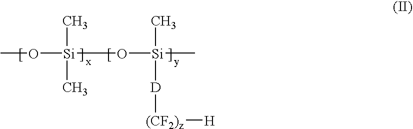

wherein D is an alkyl or alkylene group having 1 to about 10 carbon atoms and which may have ether linkages between carbon atoms; x>0; y>1; x+y=2 to 1000; and z is 1 to 20. A preferred material for use herein is a polymeric material prepared from monomer mixtures containing fluorinated siloxane-containing monomers having the following general formula III:

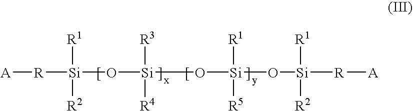

wherein R is an alkyl or alkylene group having 1 to about 10 carbon atoms and which may have ether linkages between carbon atoms; R¹-R⁴ may independently be a monovalent hydrocarbon radical or a halogen substituted monovalent hydrocarbon radical having 1 to about 18 carbon atoms which may have ether linkages between carbon atoms; x>0; y>1; x+y=2 to 1000; and z is 1 to 20; and R⁵ is independently a fluorinated side chain having the general formula:

-D-(CF₂)_{z}—H

wherein z is 1 to 20; D is an alkyl or alkylene group having 1 to about 10 carbon atoms and which may have ether linkages between carbon atoms; and A is independently an activated unsaturated group, such as an ester or amide of an acrylic or a methacrylic acid, a styryl group, or is a group represented by the general formula:

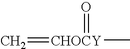

wherein Y is —O—, —S— or —NH—.

Preferably, the fluorinated side group is represented by the formula:

—CH₂—CH₂—CH₂—O—CH₂—(CF₂)_{z}—H

where z is 1 to 20. One preferred fluorinated siloxane-containing monomer, is prepared according to the following reaction scheme:

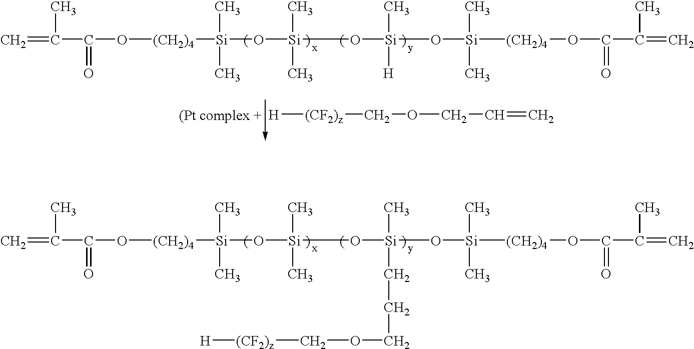

wherein y is 10, 25 and 40; x+y is 100; and z is 4 or 6.

In another embodiment, the fluorinated siloxane-containing monomers are fluorinated bulky polysiloxanylalkyl (meth)acrylate monomers represented by general formula (IV):

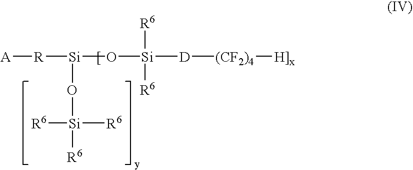

wherein A is an activated unsaturated group, such as an ester or amide of an acrylic or a methacrylic acid or a styryl group; R⁶ is independently CH₃ or H; R is an alkyl or alkylene group having 1 to about 10 carbon atoms and which may have ether linkages between the carbon atoms; D is independently an alkyl or alkylene group having 1 to about 10 carbon atoms and which may have ether linkages between carbon atoms; x is 1, 2 or 3; y is 0, 1, or 2; and x+y=3.

In another embodiment, fluorinated bulky polysiloxanylalkyl monomers for use herein can be represented by the general formula:

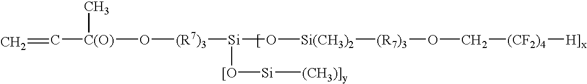

wherein R⁷ is CH₂; and x is 1, 2 or 3; y is 0, 1 or 2; and x+y=3.

Another class of fluorinated materials that can be surface treated by the methods of the present invention is highly fluorinated non-hydrogel materials. Highly fluorinated polymer materials have at least about 10 mole percent fluorine atoms, preferably about 20 to about 70 mole percent fluorine, again based on the amounts and structural formulae of the components of the polymer. Such materials include, for example, high-Dk fluoropolymeric rigid-gas-permeable contact-lens articles made from material containing at least perfluorinated monomers. An especially advantageous (high-Dk) material includes an amorphous copolymer of perfluoro-2,2-dimethyl-1,3-dioxole (PDD) with one or more copolymerizably acceptable ethylenically unsaturated fluorinated comonomers, the proportion of perfluoro-2,2-dimethyl-1,3-dioxole in the copolymer being at least about 20 mole percent of the copolymer. The latter material may further include from about 10 to about 80 weight percent of one or more other comonomers such as, for example, tetrafluoroethylene, hexafluoropropylene, chlorotrifluoroethylene (CTFE), vinylidene fluoride, perfluoro(alkyl vinyl)ether (PAVE) having the formula CF₂—CFO(CF₂ CFXO)ₙ R_{f} wherein X is independently F or CF₃, n is 0-5, and R_{f} is a perfluoroalkyl group of 1 to about 6 carbon atoms, and mixtures thereof. Another class of highly fluorinated non-hydrogel materials is xerogels or elastomers, an example of which is disclosed in U.S. Pat. No. 5,714,557.

Other hydrogel and non-hydrogel materials may be prepared from a monomeric mixture including at least one or more fluorinated silicone-containing monomers. Suitable fluorinated silicone-containing monomers include fluorosilicone monomers such as, for example, fluoroalkyl(meth)acrylates, fluorosilicone itaconates and the like and combinations thereof.

In one embodiment, a method of the present invention includes at least (a) plasma treating the fluorinated biomedical device with a hydrogen-containing atmosphere to reduce the fluorine or C—F bonding content of the fluorinated biomedical device; and (b) subjecting the surface to a plasma-polymerization reaction in a hydrocarbon-containing atmosphere to form a polymeric carbonaceous layer on the surface of the biomedical device.

In step (a) of a method of the present invention, a surface of a fluorinated biomedical device is subjected to a hydrogen plasma treatment to defluorinate the surface of the device. The hydrogen plasma treatment of a fluorine-containing material advantageously results in the loss of fluorination and/or C—F bonding at a depth in the surface of the device to allow for subsequent surface treatments, e.g., over a surface depth of approximately 74 angstroms (Å) into the material. The fluorine content in the top about 74 Å of the surface, before or after the treatments according to the present invention, can be measured, for example, by XPS analysis. See, for example, C. D. Wagner, W. M. Riggs, L. E. Davis, J. F. Moulder, Handbook of X-ray Photoelectron Spectroscopy, Perkin-Elmer Physical Electronics Division, 6509 Flying Cloud Drive, Eden Prairie, Minn., 1978; D. M. Hercules, S. H. Hercules, “Analytical Chemistry of Surfaces, Part II. Electron Spectroscopy,” Journal of Chemical Education, 61, 6, 483, 1984; D. M. Hercules, S. H. Hercules, “Analytical Chemistry of Surfaces,” Journal of Chemical Education, 61, 5, 402, 1984, which are all hereby incorporated by reference. The determination of the depth of the analysis is based on the following equation:

(KE)=hv−BE−φ

wherein hv=1486.6 eV (electron Volts) is the energy of the photon (e.g., the x-ray energy of the A1 anode), KE is the kinetic energy of the emitted electrons detected by the spectrometer in the XPS analysis, and phi is the work function of the spectrometer. BE is the binding energy of an atomic orbital from which the electron originates and is particular for an element and the orbital of that element. For example, the binding energy of carbon (aliphatic carbon or CHₓ) is 285.0 eV and the binding energy of fluorine (in a C—F bond) is 689.6 eV. Furthermore,

(KE)^{1/2}=λ

δ=3λ sin θ

wherein θ is the takeoff angle of the XPS measurement (e.g., 45°), δ is the depth sampled (about 74 Å), and λ is the mean free path or escape depth of an electron. As a rule of thumb, λ is utilized to estimate sampling depth since this accounts for about 95% of the signal originating from the sample.

Hydrogen plasmas have been found to reduce fluorination by attacking C—F bonds and forming C—H bonds. In the present invention, the surface chemistry of the fluorinated material is reduced to allow for subsequent surface treatments to be carried out, e.g., subjecting the surface to an oxidizing source to react with the defluorinated sites at the surface to form reactive functionalities thereon. Such a preliminary reduction advantageously assists in reducing or eliminating the delamination of the surface modified biomedical device. While investigating the dynamics of hydrogen plasma with fluorinated substrates, it has been discovered that the silicone backbone in fluorosilicone materials could be removed by action of the plasma. As mentioned above, it is believed that the hydrogen gas forms HF gas which attacks the silicone backbone, and this is believed to convert much or most of the polymer backbone at the surface to aliphatic carbon species, thus tending to increase the carbon content of the surface. A substantial part of the original C—F bonding may be removed by the hydrogen plasma modification followed by the reaction of the defluorinated sites with the optional oxidizing source to form reactive functionalities on the surface or hydrocarbon-containing atmosphere to form a polymeric carbonaceous layer. By the term “C—F bonding” is meant the total C—F bonding, whether in —CF, —CF₂ or —CF₃ groups.

Thus, the fluorine or C—F bonding content can be reduced to a level sufficient to allow reactive functionalities to be attached to the surface and subsequent layers to be formed, e.g., a reduction in fluorine by at least about 25 percent, preferably at least about 50 percent, and most preferably at least about 75 percent, over the first about 74 Å of the surface as determined by XPS analysis. The present invention also covers a contact lens, which when in the unhydrated state as is the condition of XPS analysis, has a surface coating characterized by a fluorine or C—F bonding content within a depth of about 74 Å that is at least about 25 percent, preferably at least about 50 percent, depleted relative to the bulk material.

The hydrogen (being present in excess) is also believed to fill radical sites on the polymer surface allowing chemical reduction of the polymer. Without wishing to be bound by theory, since the plasma gas-phase reactions on the surface of a material are complex, it is believed that typically the hydrogen of a hydrogen-gas-containing plasma reacts with fluorine at the surface of the lens, forming HF which can be carried off by a vacuum or mechanical pump during the process, thereby reducing fluorinated surface chemistries. Thus, the methods of the present invention utilize a hydrogen-gas-containing plasma to reduce fluorinated surface chemistries.

In the case of fluorosilicone materials, the HF formed in the gas phase can be utilized to attack the silicone backbone of the polymer. The fluorine is believed to chemically react with the silicon atoms in the film, thereby forming SiFx species. When such a species has four fluorine atoms (SiF₄), the molecule can be pumped off by the vacuum, causing the loss of silicon from the film. At the same time, the large excess in hydrogen molecules causes the addition of hydrogen to the remaining chemistry, the hydrogen further reducing the surface of the lens material. The hydrogen-reduced surface of the lens can then be further modified.

The process conditions of the hydrogen plasma treatment of step (a) of the method of the present invention may be substantially the same as those in conventional plasma polymerization. The degree of vacuum during plasma polymerization may be about 1×10⁻³ to 1 torr and the flow rate of the gas flowing into the reactor may be, for example, about 0.1 to about 300 cc (STP)/min in the case of the reactor having an inner volume of about 100 liter. The above-mentioned hydrogen gas may be mixed with an inert gas such as argon, helium, xenon, neon or the like before or after being charged into the reactor. The addition of halogenated alkanes is unnecessary but not deleterious, and may be present in combination with the hydrogen, preferably at an atomic ratio of less than about 10 percent of gaseous halogen to hydrogen. The substrate temperature during plasma polymerization is not particularly limited, but is preferably between about 0° C. to about 300° C.

The type of discharge to be used for the generation of plasma is not particularly limited and may involve the use of DC discharge, low frequency discharge, high frequency discharge, corona discharge or microwave discharge. Also, the reaction device to be used for the plasma polymerization is not particularly limited. Therefore, either an internal electrode system or an electrodeless system may be utilized. There is also no limitation with respect to the shape of the electrodes or coil, or to the structure or the cavity or antenna in the case of microwave discharge. Any suitable device for plasma polymerization, including known or conventional devices, can be utilized.

Preferably, the plasma is produced by passing an electrical discharge, preferably at radio frequency (typically, about 13.56 MHz), through a gas at low pressure (about 0.005 to about 5.0 torr). Accordingly, the applied radio frequency power is absorbed by atoms and molecules in the gaseous state, and a circulating electrical field causes these excited atoms and molecules to collide with one another as well as the walls of the chamber and the surface of the material being treated. Electrical discharges produce ultraviolet (UV) radiation, in addition to energetic electrons and ions, atoms (ground and excited states), molecules and radicals. Thus, a plasma is a complex mixture of atoms and molecules in both ground and excited states which reach a steady state after the discharge is begun.

The effects of changing pressure and discharge power on the plasma treatment is generally known to the skilled artisan. The rate constant for plasma modification generally decreases as the pressure is increased. Thus, as pressure increases the value of E/P, the ratio of the electric field strength sustaining the plasma to the gas pressure, decreases and causes a decrease in the average electron energy. The decrease in electron energy in turn causes a reduction in the rate coefficient of all electron-molecule collision processes. A further consequence of an increase in pressure is a decrease in electron density. Taken together, the effect of an increase in pressure is to cause the rate coefficient to decrease. Providing that the pressure is held constant there should be a linear relationship between electron density and power. Thus, the rate coefficient should increase linearly with power.

The deposition of a coating from a plasma onto the surface of a material has been shown to be possible from high-energy plasmas without the assistance of sputtering (sputter-assisted deposition). Monomers can be deposited from the gas phase and polymerized in a low pressure atmosphere (about 0.005 to about 5 torr, and preferably about 0.001 to about 1 torr) onto a substrate utilizing continuous or pulsed plasmas, suitably as high as about 1000 watts. A modulated plasma, for example, may be applied about 100 milliseconds on then off. In addition, liquid nitrogen cooling has been utilized to condense vapors out of the gas phase onto a substrate and subsequently use the plasma to chemically react these materials with the substrate. However, plasmas do not require the use of external cooling or heating to cause the deposition. Low or high wattage (e.g., about 5 to about 1000, and preferably about 20 to about 500 watts) plasmas can coat even the most chemical-resistant substrates, including silicones.

After initiation by a low energy discharge, collisions between energetic free electrons present in the plasma cause the formation of ions, excited molecules, and free-radicals. Such species, once formed, can react with themselves in the gas phase as well as with further ground-state molecules. The plasma treatment may be understood as an energy dependent process involving energetic gas molecules. For chemical reactions to take place at the surface of the lens, one needs the required species (element or molecule) in terms of charge state and particle energy. Radio frequency plasmas generally produce a distribution of energetic species. Typically, the “particle energy” refers to the average of the so-called Boltzman-style distribution of energy for the energetic species. In a low-density plasma, the electron energy distribution can be related by the ratio of the electric field strength sustaining the plasma to the discharge pressure (E/p). The plasma power density P is a function of the wattage, pressure, flow rates of gases, etc., as will be appreciated by the skilled artisan. Background information on plasma technology, hereby incorporated by reference, includes the following: A. T. Bell, Proc. Intl. Conf. Phenom. Ioniz. Gases, “Chemical Reaction in Nonequilibrium Plasmas”, 19-33 (1977); J. M. Tibbitt, R. Jensen, A. T. Bell, M. Shen, Macromolecules, “A Model for the Kinetics of Plasma Polymerization”, 3, 648-653 (1977); J. M. Tibbitt, M. Shen, A. T. Bell, J. Macromol. Sci.-Chem., “Structural Characterization of Plasma-Polymerized Hydrocarbons”, A10, 1623-1648 (1976); C. P. Ho, H. Yasuda, J. Biomed, Mater. Res., “Ultrathin coating of plasma polymer of methane applied on the surface of silicone contact lenses”, 22, 919-937 (1988); H. Kobayashi, A. T. Bell, M. Shen, Macromolecules, “Plasma Polymerization of Saturated and Unsaturated Hydrocarbons”, 3, 277-283 (1974); R. Y. Chen, U.S. Pat. No., 4,143,949, Mar. 13, 1979, “Process for Putting a Hydrophilic Coating on a Hydrophobic Contact lens”; and H. Yasuda, H. C. Marsh, M. O. Bumgarner, N. Morosoff, J. of Appl. Poly. Sci., “Polymerization of Organic Compounds in an Electroless Glow Discharge. VI. Acetylene with Unusual Co-monomers”, 19, 2845-2858 (1975).

Based on this previous work in the field of plasma technology, the effects of changing pressure and discharge power on the rate of plasma modification can be understood. The rate generally decreases as the pressure is increased. Thus, as pressure increases the value of E/p, the ratio of the electric field strength sustaining the plasma to the gas pressure decreases and causes a decrease in the average electron energy. The decrease in electron energy in turn causes a reduction in the rate coefficient of all electron-molecule collision processes. A further consequence of an increase in pressure is a decrease in electron density. Providing that the pressure is held constant, there should be a linear relationship between electron density and power.

The plasma treatments herein, for example, hydrogen or hydrogen in an inert gas such as argon, and an oxidizing source such as an methanol or ammonia may suitably utilize an electric discharge frequency of, for example, 13.56 MHz, between about 100 to about 1000 watts, preferably about 200 to about 800 watts, and more preferably about 300 to about 500 watts, and at a pressure of about 0.1 to about 1.0 torr. The plasma-treatment time is a time period sufficient to form the oxidized layer on the surface of the device and is within the purview of one skilled in the art, e.g., a time period of at least a few seconds.

Optionally, the lens may be flipped over to better treat both sides of the lens. The plasma-treatment gas is suitably provided at a flow rate of about 50 to about 500 sccm (standard cubic centimeters per minute), more preferably about 100 to about 300 sccm. The thickness of the surface treatment is sensitive to plasma flow rate and chamber temperature, as will be understood by the skilled artisan. Since the coating is dependent on a number of variables, the optimal variables for obtaining the desired or optimal coating may require some adjustment. If one parameter is adjusted, a compensatory adjustment of one or more other parameters may be appropriate, so that some routine trial and error experiments and iterations thereof may be necessary in order to achieve the coating according to the present invention. However, such adjustment of process parameters, in light of the present disclosure and the state of the art in plasma treatment, should not involve undue experimentation. As indicated above, general relationships among process parameters are known by the skilled artisan, and the art of plasma treatment has become well developed in recent years.

Prior to forming a hydrocarbon polymeric layer on the surface of the device, it may be useful to treat the surface of the hydrogen-plasma-treated fluorinated material with an oxidizing source to more effectively bond the polymerized hydrocarbon coating to the lens in order to resist delamination and/or cracking of the surface coating from the lens upon, for example, lens hydration. Generally, plasma oxidization can be accomplished employing any suitable oxidizing source capable of being vaporized. Suitable oxidizing sources include inorganic and/or organic oxidizing sources. In one embodiment, an oxidizing source is an oxygen, sulfur and/or nitrogen-containing plasma. Representative examples of an oxidizing source include, but are not limited to, plasma gas containing ammonia, air, water, peroxide, O₂ (oxygen gas), alcohols, e.g., methanol and the like, ketones, e.g., acetone and the like, alkylamines, as well as other gases such as sulfur dioxide, sulfur oxide, phosphorus monoxide, phosphorus dioxide, carbon monoxide, carbon dioxide, nitric oxide, nitric dioxide and combinations thereof. As one skilled in the art will readily appreciate, the oxidizing source will form a film or layer over the surface of the device after the surface has been defluorinated. Depending on the particular type of oxidizing source used, the film or layer can be, for example, grafted or plasma polymerized on the surface of the device.

A fluorinated biomedical device herein can be first subjected to a plasma treatment of a hydrogen-plasma and then further subjected to an oxidizing source creating radicals and oxidized functional groups. Alternatively, a fluorinated biomedical device can be subjected to a simultaneous plasma treatment of a hydrogen-containing atmosphere in the presence of an oxidizing source thereby creating radicals and oxidized functional groups.

In one embodiment, the hydrogen plasma treatment of a fluorine-containing material has been found to cause the loss of fluorination and/or C—F bonding over a surface depth of approximately 74 Å into the material. Accordingly, oxidization of the surface can result in an increase in the nitrogen, sulfur and/or oxygen content by at least about 5 percent over the first about 74 Å of the surface as determined by XPS analysis, before further processing of the device such as extraction or heat sterilization. The present invention also covers a contact lens, which when in the unhydrated state as is the condition of XPS analysis, has a surface coating characterized by an oxygen content within a depth of about 74 Å that is at least about 2 mole percent enriched relative to the bulk material, based on XPS analysis.

Following step (a) or optional oxidizing step, a hydrocarbon polymeric layer is formed on the surface by subjecting the surface to a plasma polymerization reaction in a hydrocarbon-containing atmosphere to form a polymeric carbonaceous layer on the device. Any hydrocarbon capable of polymerizing in a plasma environment may be utilized; however, it is usually necessary that the hydrocarbon be in a gaseous state during polymerization and have a boiling point below about 200° C. at about one atmosphere. Suitable hydrocarbons include, but are not limited to, linear or branched, saturated and unsaturated, C₁ to about C₁₅ aliphatic compounds, C₁ to about C₈ aromatic compounds and the like and mixtures thereof. Examples of such aliphatic hydrocarbons include, but are not limited to, C₁ to about C₁₅, and preferably C₁ to about C₁₀ alkanes, alkenes, or alkynes and the like. Specific examples of suitable aliphatic hydrocarbons include methane, ethane, propane, butane, pentane, hexane, ethylene, propylene, butylene, cyclohexane, pentene, acetylene and the like. Specific examples of suitable aromatic hydrocarbons include benzene, styrene, methylstyrene, and the like. As is known in the art, such hydrocarbon groups may be unsubstituted or substituted so long as they are capable of forming a plasma. In one embodiment, the hydrocarbon is a diolefin such as, for example, 1,3-butadiene or isoprene.

The use of C₁ to C₄ hydrocarbons for the purpose of carbon-coating substrates is advantageous for its controllability in terms of thickness, deposition rate, hardness, etc. However, with respect to hydrogel materials, the C₄ to C₈ hydrocarbons (e.g., butane, butene, isobutylene, and 1,3-butadiene) are preferred, at least with respect to hydrogel-forming substrates, due to the relative less flexibility of coatings made from C₁ to C₃ hydrocarbons such as methane. Such coatings may suffer during the expansion of the hydrogel substrate in water or saline and are more prone to cracking, which is less desirable. The use of longer carbon chains in the deposition plasma gas results in coatings that are more flexible. The longer carbon chain coatings have been found to be more expandable, especially when coating hydrogel substrates in saline or water.

The hydrocarbon-containing coating can be deposited from plasma, for example, in a low-pressure atmosphere (about 0.001 to about 5 torr) at a radio frequency of about 13.56 Mhz, at about 10 to about 1000 watts, and preferably about 20 to about 400 watts in about 30 seconds to about 10 minutes or more, and more preferably about 30 seconds to about 3 minutes. Other plasma conditions may be suitable as will be understood by the skilled artisan, for example, using pulsed plasma.

If the coating provided is too thick, it can cause a haziness, resulting in a cloudy lens. Furthermore, excessively thick coatings can interfere with lens hydration due to differences in expansion between the lens and the coating, causing the lens to rip apart. Therefore, the thickness of the hydrocarbon layer should ordinarily be less than about 500 Å, preferably from about 25 to about 500 Å, and more preferably from about 50 to about 200 Å, as determined by XPS analysis.

If desired, the polymeric carbonaceous coating layer may then be subjected to addition surface treatments. For example, the polymeric carbonaceous coating layer may be treated with an oxidizing source to provide reactive functionalities on the polymeric carbonaceous layer. Alternatively, the polymeric carbonaceous coating layer may be treated with an oxidizing source to provide reactive functionalities on the polymeric carbonaceous layer; and a biocompatible material may be reacted with the reactive functionalities on the surface of the device. Suitable biocompatible materials include, but are not limited to, hydrophilic polymers (including macromonomers and oligomers) as disclosed in the prior art. The attachment of biocompatible materials such as hydrophilic polymers to chemical or reactive functionalities on the surface of the device and suitable polymers and their preparation are disclosed in, for example, U.S. Pat. No. 6,630,243. Other patents or literature references teaching the attachment of hydrophilic polymers to the functionalized surface of a material will be known to the skilled artisan. Attachment of the biocompatible material with the chemical or reactive functionalities can be via covalent bonding, ionic bonding, hydrogen bonding, hydrophobic association and the like.

Subsequent to surface treatment, the surface modified biomedical devices of the present invention may be subjected to extraction to remove residuals in the lenses. Generally, in the manufacture of contact lenses, some of the monomer mix is not fully polymerized. The incompletely polymerized material from the polymerization process may affect optical clarity or may be harmful to the eye. Residual material may include solvents not entirely removed by the previous solvent removal operation, unreacted monomers from the monomeric mixture, oligomers present as by-products from the polymerization process, or even additives that may have migrated from the mold used to form the lens.

Conventional methods to extract such residual materials from the polymerized contact lens material include extraction with an alcohol solution for several hours (for extraction of hydrophobic residual material) followed by extraction with water (for extraction of hydrophilic residual material). Thus, some of the alcohol extraction solution remains in the polymeric network of the polymerized contact lens material, and should be extracted from the lens material before the lens may be worn safely and comfortably on the eye. Extraction of the alcohol from the lens can be achieved by employing heated water for several hours. Extraction should be as complete as possible, since incomplete extraction of residual material from lenses may contribute adversely to the useful life of the lens. Also, such residuals may impact lens performance and comfort by interfering with optical clarity or the desired uniform hydrophilicity of the lens surface. It is important that the selected extraction solution in no way adversely affects the optical clarity of the lens. Optical clarity is subjectively understood to be the level of clarity observed when the lens is visually inspected.

Subsequent to extraction, the lens can be subjected to hydration in which the lens is fully hydrated with water, buffered saline, and the like. When the lens is ultimately fully hydrated (wherein the lens typically may expand by about 10 to about 20 percent or more), the coating remains intact and bound to the lens, providing a durable, hydrophilic coating which has been found to be resistant to delamination.

Following hydration, the lens may undergo cosmetic inspection wherein trained inspectors inspect the contact lenses for clarity and the absence of defects such as holes, particles, bubbles, nicks, tears. Inspection is preferably at 10× magnification. After the lens has passed the steps of cosmetic inspection, the lens is ready for packaging, whether in a vial, plastic blister package, or other container for maintaining the lens in a sterile condition for the consumer. Finally, the packaged lens is subjected to sterilization, which sterilization may be accomplished in a conventional autoclave, preferably under an air pressurization sterilization cycle, sometime referred to as an air-steam mixture cycle, as will be appreciated by the skilled artisan. Preferably, autoclaving is carried out at about 100° C. to about 200° C. for a period of about 10 to about 120 minutes. Following sterilization, the lens dimension of the sterilized lenses may be checked prior to storage.

It will be understood that various modifications may be made to the embodiments disclosed herein. Therefore the above description should not be construed as limiting, but merely as exemplifications of preferred embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the features and advantages appended hereto.

What is claimed is:

1. A method for treating a fluorinated biomedical device, the method comprising the steps of (a) plasma treating the fluorinated biomedical device with a hydrogen-containing atmosphere to reduce the fluorine or C—F bonding content of the fluorinated biomedical device; and (b) subjecting the hydrogen plasma treated surface to a plasma-polymerization reaction in a hydrocarbon-containing atmosphere to form a polymeric carbonaceous layer on the surface of the biomedical device.

2. The method of claim 1, wherein the fluorinated biomedical device is a fluorinated silicone-containing ophthalmic device.

3. The method of claim 2, wherein the fluorinated silicone-containing ophthalmic device is a fluorinated silicone-containing ophthalmic lens.

4. The method of claim 2, wherein the fluorinated silicone-containing ophthalmic device is a fluorinated silicone-containing contact lens.

5. The method of claim 2, wherein the fluorinated silicone-containing ophthalmic device is a polymerization product of a monomeric mixture comprising a fluorine-containing silicone monomer.

6. The method of claim 5, wherein the monomer is a poly(organosiloxane) capped with an unsaturated group at two ends containing a fluorinated side group.

7. The method of claim 5, wherein the monomer contains a pendant fluorinated alkyl group containing a —CF₂— group or a —CHF₂ or —CF₃ end group.

8. The method of claim 5, wherein the monomer comprises a fluorinated derivative of a polysiloxanylalkyl (meth)acrylate monomer.

9. The method of claim 1, wherein the fluorine content is reduced by at least about 25 percent over the first 74 angstroms (Å) of the surface as determined by x-ray photoelectron spectroscopy (XPS) analysis.

10. The method of claim 1, wherein the fluorine content is reduced by at least about 75 percent over the first 74 Å of the surface as determined by XPS analysis.

11. The method of claim 1, wherein the hydrocarbon-containing atmosphere comprises a diolefin having four to eight carbon atoms.

12. The method of claim 1, wherein the plasma polymerization reaction of step (b) is conducted in an atmosphere comprising isoprene and/or 1,3-butadiene.

13. The method of claim 1, further comprising (a) plasma treating the fluorinated biomedical device with a hydrogen-containing atmosphere to reduce the fluorine or C—F bonding content of the fluorinated biomedical device; (b) oxidizing the surface with an oxidizing source; and (c) subjecting the oxidized surface to a plasma-polymerization reaction in a hydrocarbon-containing atmosphere to form a polymeric carbonaceous layer on the surface of the biomedical device.

14. The method of claim 13, wherein the oxidizing source comprises an inorganic material.

15. The method of claim 13, wherein the oxidizing source comprises an organic material.

16. The method of claim 13, wherein the oxidizing source comprises a nitrogen, oxygen and/or sulfur-containing oxidizing gas.

17. The method of claim 1, further comprising (a) plasma treating the fluorinated biomedical device with a hydrogen-containing atmosphere to reduce the fluorine or C—F bonding content of the fluorinated biomedical device; (b) oxidizing the surface with a first oxidizing source; and (c) subjecting the oxidized surface to a plasma-polymerization reaction in a hydrocarbon-containing atmosphere to form a polymeric carbonaceous layer on the surface of the biomedical device; and (d) oxidizing the polymeric carbonaceous layer with a second oxidizing source to provide reactive functionalities on the polymeric carbonaceous layer.

18. The method of claim 1, further comprising (a) plasma treating the fluorinated biomedical device with a hydrogen-containing atmosphere to reduce the fluorine or C—F bonding content of the fluorinated biomedical device; (b) oxidizing the surface with a first oxidizing source; (c) subjecting the oxidized surface to a plasma-polymerization reaction in a hydrocarbon-containing atmosphere to form a polymeric carbonaceous layer on the surface of the biomedical device; (d) oxidizing the polymeric carbonaceous layer with a second oxidizing source to provide reactive functionalities on the polymeric carbonaceous layer; and (e) reacting a biocompatible material with the reactive functionalities on the surface of the device.

19. The method of claim 18, wherein the biocompatible material is a hydrophilic polymer.

20. The method of claim 18, wherein the reactive functionalities are covalently attached to the biocompatible material.

21. A method for treating a fluorinated biomedical device, the method comprising the steps of (a) plasma treating the fluorinated biomedical device with a hydrogen-containing atmosphere in the presence of an oxidizing source; and (b) subjecting the oxidized surface to a plasma-polymerization reaction in a hydrocarbon-containing atmosphere to form a polymeric carbonaceous layer on the surface of the biomedical device.

22. The method of claim 21, wherein the fluorinated biomedical device is a fluorinated silicone-containing ophthalmic device.

23. The method of claim 22, wherein the fluorinated silicone-containing ophthalmic device is a fluorinated silicone-containing ophthalmic lens.

24. The method of claim 22, wherein the fluorinated silicone-containing ophthalmic device is a fluorinated silicone-containing contact lens.

25. The method of claim 21, further comprising (a) plasma treating the fluorinated biomedical device with a hydrogen-containing atmosphere in the presence of a first oxidizing source; (b) subjecting the oxidized surface to a plasma-polymerization reaction in a hydrocarbon-containing atmosphere to form a polymeric carbonaceous layer on the surface of the biomedical device; and (c) oxidizing the polymeric carbonaceous layer with a second oxidizing source to provide reactive functionalities on the polymeric carbonaceous layer.
